(19) United States
(12) Patent Application Publication
(10) Pub. No.: US 2009/0016512 A1
(43) Pub. Date: Jan. 15, 2009

(54) Rules-Based On Hold Control During an Interactive Teleconference Session

(76) Inventors: Raquel B. Bryant, Raleigh, NC (US); Veronique L. Moses, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/776,020

(22) Filed: Jul. 11, 2007

(51) Int. Cl. H04M 3/42

(52) U.S. Cl. 379/202.01

(57) ABSTRACT

Putting and removing participants to and from “on hold” during an interactive teleconference is based on pre-determined rules. These pre-determined rules define conditions that must be met before participants are allowed to transmit messages during the interactive teleconference. As soon as the conditions are met, affected participants are allowed to transmit messages during the interactive teleconference.

### BACKGROUND OF THE INVENTION

The present disclosure relates to the field of computers, and specifically to software. Still more specifically, the present disclosure relates to interactive teleconferencing sessions.

Interactive teleconferencing technology is used to communicate either to an individual via peer to peer chats, or to a group of individuals through establishing a group chat discussion where 1 to n (where “n” is an integer) individuals can join. Such teleconferencing has become an integral part of both personal and professional lives, and is often replacing and supplementing well known means of communication such as email, phone and face-to-face conversations. Examples of such interactive telecommunication (teleconferencing) include, but are not limited to, Instant Messaging (IM), video teleconferences, web conferences, conference telephone calls, and other similar electronic means of communication.

### BRIEF SUMMARY OF THE INVENTION

Placing and removing participants from an “on hold” status during an interactive teleconference is based on predetermined rules. These predetermined rules define conditions that must be met before participants are allowed to transmit messages during the interactive teleconference. As soon as the conditions are met, affected participants are allowed to transmit messages during the interactive teleconference.

The above as well as additional objectives, features, and advantages of the present invention will become apparent in the following detailed written description.

### BRIEF DESCRIPTION OF THE SEVERAL VIEWS OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary computer in which the present invention may be implemented;

FIG. 2 illustrates a relationship between an Instant Messaging (IM) session host and IM session participants;

FIG. 3 depicts an exemplary “Start IM” GUI, in which invitees are initially placed on hold, and thus are unable to transmit IM text messages;

FIG. 4 illustrates an IM host's GUI that shows the names of invitees to an IM session, plus control buttons that control whether the invitees are on hold or not;

FIG. 5 depicts a pop-up that allows an invitee to be placed on or released from hold;

FIG. 6 illustrates the IM host's GUI being able to place one or all IM session invitees on hold;

FIG. 7 is a flow-chart of exemplary steps taken to manage the placement and removal of “on hold” status for IM session invitees;

FIG. 8 is an exemplary GUI used to set up a rule for a teleconference; and

FIG. 9 is an exemplary GUI used to track the progress of a rule being met for the teleconference that was set up in FIG. 8.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

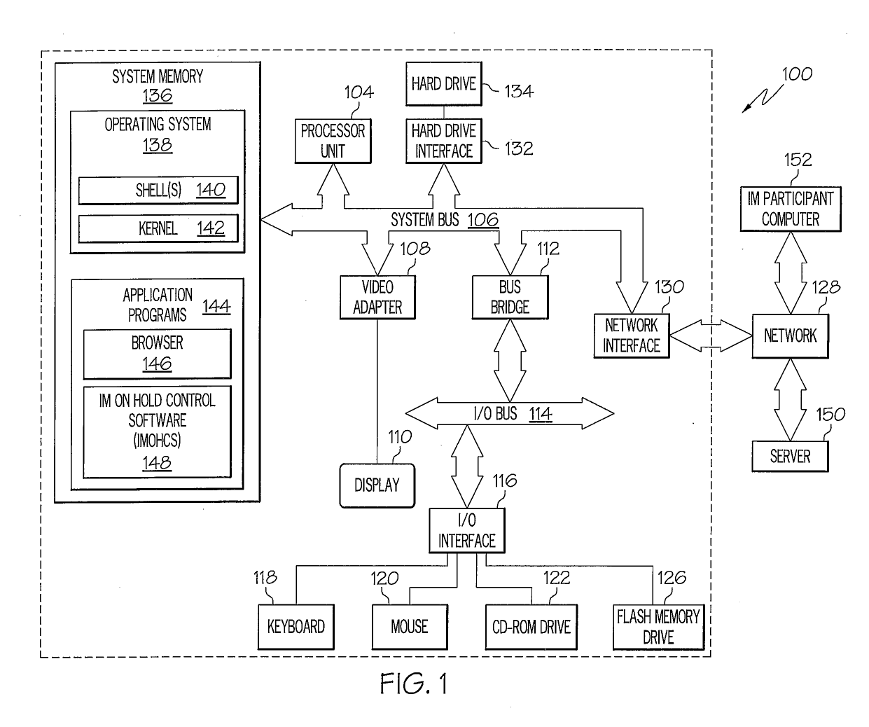

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 and an IM Participant Computer 152 via a network 128 using a network interface 130, which is coupled to system bus 106. Network 128 may be an external network such as the Internet, or an internal network such as an Ethernet or a Virtual Private Network (VPN). Server 150 and IM Participant Computer 152 may be architecturally configured in the manner that is substantially similar to that depicted for computer 100. In a preferred embodiment, computer 100 is utilized by a host of an IM or similar interactive teleconference session, and IM participant computer 152 is used by non-host participants in the interactive teleconference session.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

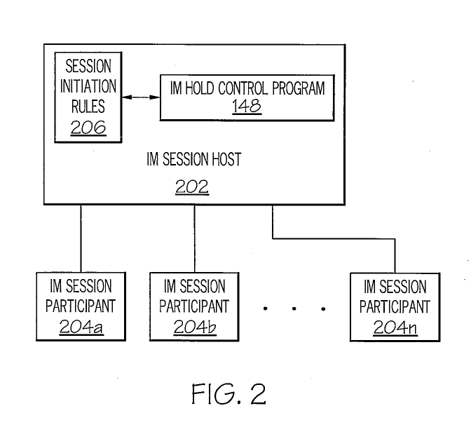

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include an Instant Messaging On-Hold Control Software (IMOHCS) 148. IMOHCS 148 performs the functions illustrated below in FIGS. 2-9, and may include the session initiation rules 206 shown below in FIG. 2. In one embodiment, computer 100 is able to download IMOHCS 148 from a service provider that is utilizing server 150, preferably in an “on demand” basis. Note further that, in a preferred embodiment of the present invention, server 150 performs all of the functions associated with the present invention (including the execution of IMOHCS 148), thus freeing computer 100 from having to use its own computing resources.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

The present invention may be utilized in any interactive teleconference environment. An interactive teleconference is understood to include any form of electronic communication between at least two parties and/or devices. Examples of such interactive teleconferences include, but are not limited to, Instant Messaging (IM) sessions, web conferences, video conferences, telephone calls, text message sessions, etc. While it is to be understood that the novelties disclosed herein are applicable to any such interactive teleconference environments, for the sake of brevity and clarity, the invention is primarily described herein in the environment of an IM session.

With reference then to FIG. 2, an overview of participants in an Instant Messaging (IM) session is presented. An IM session host 202, which may be using computer 100 described above in FIG. 1, is in communication with one or more IM session participants 204a-n, where “n” is an integer, and where IM session participants 204a-n each utilize their own computer system, such as IM participant computer 152 describe in FIG. 1. IM Session Host 202 has access to an IM Hold Control Program 148, which controls the initiation, termination, and “on-hold” functions of an IM session. In a manner that is described in further detail below, the “on-hold” functions are subject to session initiation rules 206, which are referenced by the IM Hold Control Program 148.

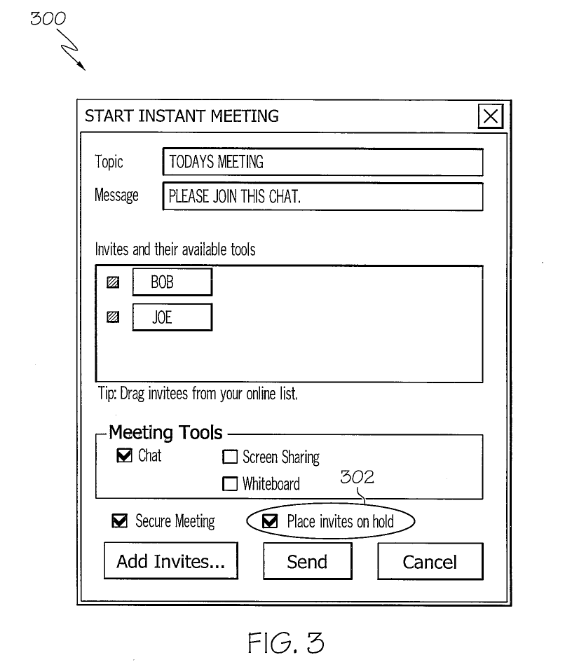

With reference now to FIG. 3, a Graphical User Interface (GUI) 300 is presented. As shown in GUI 300, an option field 302 has been added at the “Start Instant Meeting” GUI 300. Option field 302 allows the IM session host to place all pre-selected participants on hold until the IM session host has manually released the hold (see further details below), or some automatic criteria has been met. These additional automatic criteria may be added as a sub-menu (not shown) if the option “Place invitees on hold” is chosen. Such automatic criteria include, but are not limited to, all invitees being active (having signed in); a particular invitee being active; or a specific date and time have been reached. For example, the IM session host may not want to start the IM session until a key participant is there (has signed in), and/or the current time is 2:00 P.M. on a specified date.

In the example shown in FIG. 3, the IM host has started the chat session with the option selected to put invitees on hold. In one embodiment, the invitees will get a session invitation, and will then enter the session (chat) as normal. However, the invitees cannot initially participate (transmit their own messages) until the IM host releases their “on hold” buttons. In another embodiment, the invitees will not be able to receive or transmit messages in the session until released from “on hold.”

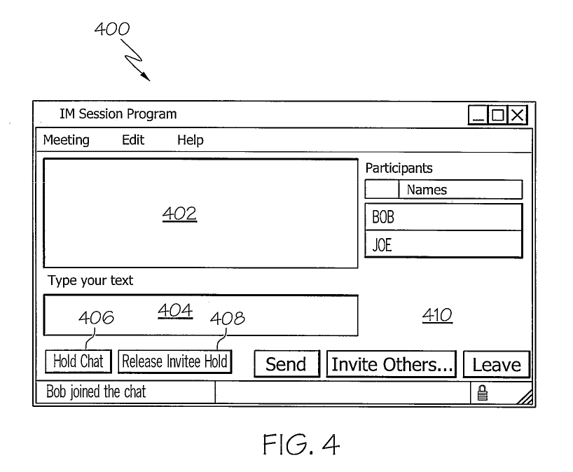

With reference now to FIG. 4, a GUI 400 shows the IM session program from the IM host's view. That is, the IM host not only has a GUI that shows a text receive box 402 and a text input box 404 (which are part of the GUI that all IM invitees see), but the IM host's GUI 400 also includes a hold chat button 406 (which, when activated, puts one or more participants “on hold”), and a release invitee hold button 408 (which takes selected participants “off hold”). These buttons implement logic within the IM Hold Control Program 148 describe above to perform the described functions. As shown, two participants (“Bob” and “Joe”) are shown as being participants in participant window 410. However, because their names are visually coded (are in a particular color, in bold, etc), the IM host knows that they are still “on hold,” and thus are not able to participate (send messages) in the IM session.

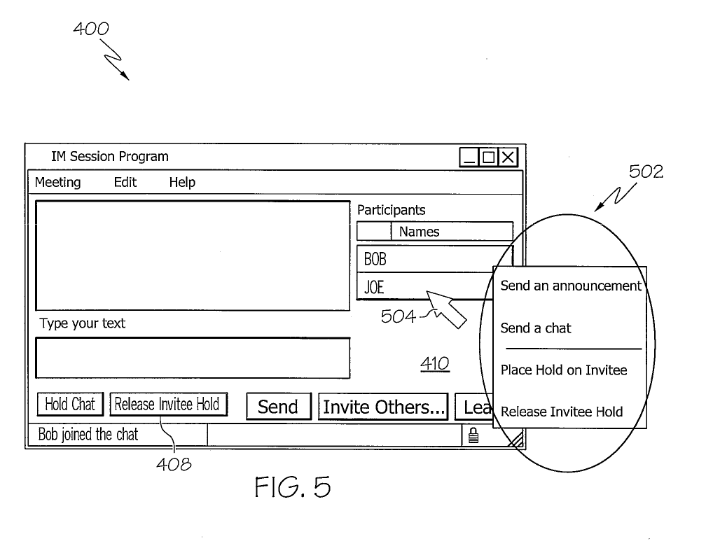

Referring now to FIG. 5, GUI 400 is once again represented. Note, however, that a pop-up 502 appears when a cursor 504 is hovered over participant window 410, preferably over a selected invitee's name. The selected invitee is then released from being “on hold” by clicking the appropriate instruction from the pop-up 502, or by clicking the release invitee hold button 408. Alternatively, a combination of key strokes (e.g., CTRL/SHIFT-Select key strokes) may be utilized to release the “on hold” status of one, more or all of the invitees, such that the released invitees are now enabled to transmit messages in the IM session.

Once the hold is released, the normal IM status cues are displayed (e.g., the color coding of a participant's name in participant window 410 changes from “RED” to “Green”, bold to normal, etc.).

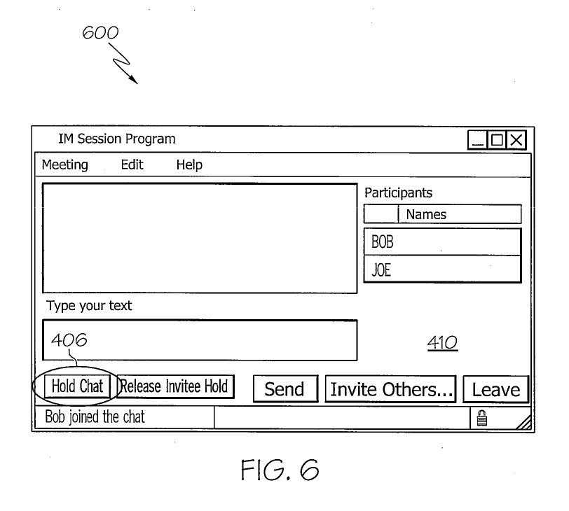

With reference now to FIG. 6, a GUI 600 shows that the IM host can place an IM meeting/conversation on hold (disabling one or more of the IM session participants' ability to send messages) even after the IM session has been initiated. By clicking the hold chat button 406, the names all invitees displayed in the participant window 410 will change from the presented “active” format (e.g., “GREEN”) to the disabled “on hold” format (e.g., “RED”). This gives the IM host the capability of placing the entire IM meeting/conversation on hold even after the session has initiated (i.e., to manage interruptions and loss content during interruptions).

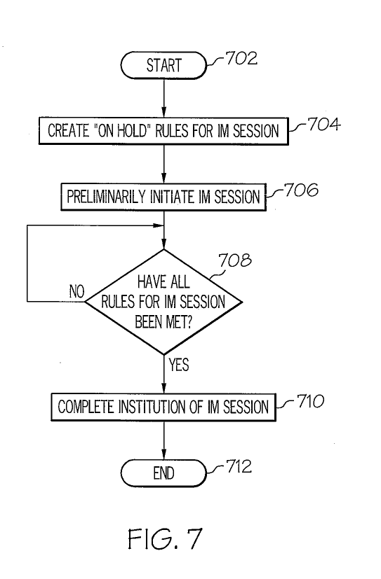

With reference now to FIG. 7, a flow-chart of exemplary steps taken to manage “on hold” status of IM invitees is presented. After initiator block 702, a set of “on hold” rules is created for an IM session (block 704). These rules may be manually created by an IM session host, or they may be automatically created in response to some external event. For example, assume that scenario includes a server farm going down. Logic associated with a detection of that event can automatically initiate an IM session with maintenance, supervisory and personnel employees, whom would all be involved in addressing the problem. This logic would also include instructions that the IM session is not to begin until all requisite participants have signed on.

As indicated in block 706, an IM session is preliminarily initiated. That is, an invitation (or reminder) is sent to all invitees to the IM session. However, these invitees are initially disabled from sending text messages. Only when the conditions of the rule have been met (query block 708) can the invitees begin sending their text messages (block 710) until the IM session ends. The narrative description of the process ends at terminator block 712.

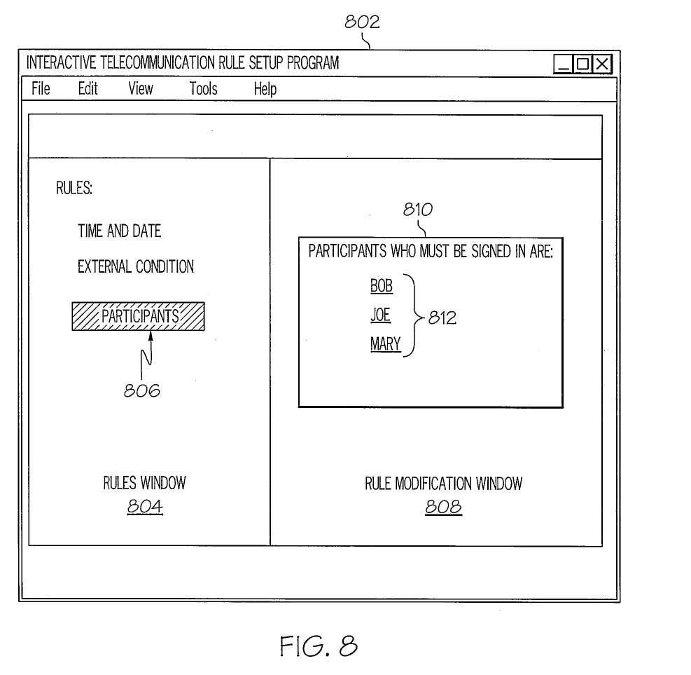

With reference now to FIG. 8, an exemplary GUI 802 is presented for setting up a rule for an interactive teleconference. As shown in rules window 804, multiple rules are presented to a user, who has selected rule 806 (“Participants”). By selecting rule 806 (e.g., by double clicking, drag-and-dropping to rule modification window 808, etc.), a rule population window 810 appears. Fields 812 allow the user to enter which participants must be signed in, in order for the teleconference to begin.

Alternatively, rules window 804 may display a user-created rule (not shown). Such a user-created rule may be based on a rudimentary template, or may be completely written in an unstructured manner using script (e.g., Structured Query Language) SQL) script, Extensible Markup Language (XML) code, etc.) that is written by the user.

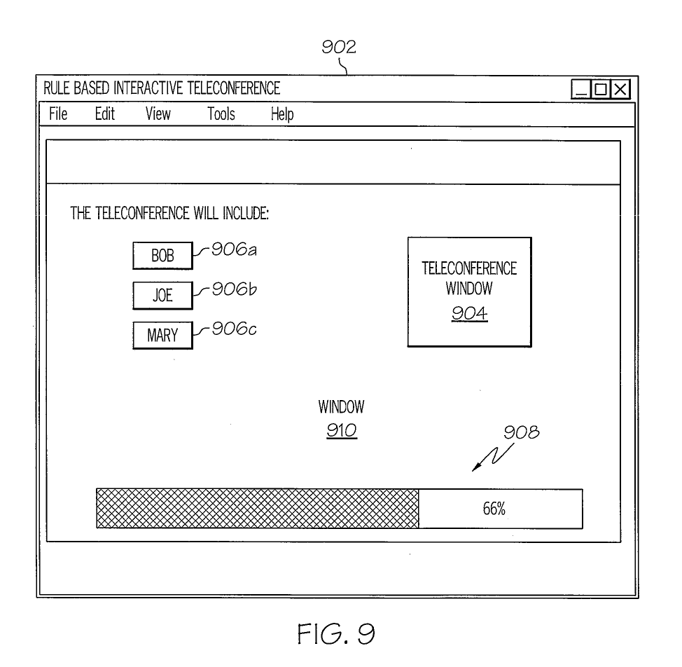

Assuming that the teleconference has been set up in accordance with the example shown in FIG. 8, then the GUI 902 shown in FIG. 9 shows a progress of the rule being met. That is, before the interactive teleconference can actually begin (e.g., through a teleconference window 904), “Bob,” “Joe,” and “Mary” must be signed in. As represented by the visual coding of icons 906a and 906b, however, only “Bob” and “Joe” have signed in. As represented by the visual coding of icon 906c, “Mary” still has not signed in, and thus the teleconference may not begin yet. Progress bar 908 graphically represents the fact that only 66% of the participants have signed in. As soon at all participants sign in (i.e., all conditions of the rule have been met), then the teleconference window 904 will automatically fill the entire window 910 (removing the display of icons 906a-c, progress bar 908, etc.), and the teleconference begins.

Note that examples of conditions that such rules are based on include, but are not limited to, 1) that all invitees have signed in; 2) that “key participant(s) (e.g., the IM host) have signed in; 3) that a date/time has been reached; and/or 4) that some external event, either beneficial or harmful to a system, has occurred.

This present disclosure thus presents a manner for integrating a hold feature such that, in the case of an instant messenger “group” chat discussion, the originator (IM host) has the ability to invite invitees to the discussion, but can put them in a hold status until entry into the current running conversation is deemed appropriate. Likewise, the originator can also put all invitees on current hold in the conversation/IM discussion, such that no discussion can happened until the originator release the hold status. Also, in the case of a single peer-to-peer discussion within IM, either participant has the ability to put the conversation on hold disallowing further conversation by both parties until the originator of the hold has released it.

Advantages over the prior art include, but are not limited to, the fact that the present methodology 1) mimics real-world communication, and gives IM users the ability to pause discussions by putting participants on “hold”; 2) allows IM users the ability to have better meeting control by defining when a meeting can start based on certain attributes such as “holding” a meeting until all invitees or a subset of invitees have joined; 3) saves time in group discussions by reducing/eliminating the need from meeting history recaps for late invitees, and in the same sense, saves time from starting a meeting when most needed invitees haven't joined; 4) for peer-to-peer discussion, interjects human characteristics such that the other invitee can know that another has an interruption and is not engaged in the conversation; and 5) incorporates the use of pre-set rules that automatically determine when one or more participants is taken “off hold.”

Thus, the ability is provided for putting invitees within a chat discussion on hold (either within a peer to peer discussion or a group discussion). In the case of a group chat discussion, the disclosure offers the capabilities of 1) the originator has the ability to invite invitees (all or a subset) to the discussion but, can put them in a hold status until appropriate entry into the current running conversation is deemed or other criteria have been met; and 2) the originator can also put all invitees on hold during an active conversation/IM discussion preventing discussion until the originator releases the hold status -- essentially pausing the conversation. In the scenario of a more limited conversation such as in peer-to-peer chats, the disclosure offers the capability of giving either invitee the ability to put the conversation on hold, thus disallowing further conversation by both parties until the originator of the hold has released it.

Note that a moderator can assign a rule when creating an event such as “begin conference and presentation display when “John Doe” is active in the conference.” Thus, when participants arrived in the conference they are active but, the conference itself is not active (on hold) until the above policy is met. Also, rules policies, after being designed at time of creation of the event, can be activated and enforced independently of the moderator's participation or presence within the collaboration event as long as the rule policy is not defined around the moderator. Thus, the moderator (IM host) can set the rules before the session or event, and those rules will be enforced by the system even if the moderator is late or doesn't attend the call.

Note again that while most of the present disclosure describes examples of controlling “on hold” functionality of an Instant Messaging scenario, the same principals taught herein are applicable to other forms of interactive teleconferences, including but not limited to video conferences, web conferences, conference telephone calls, etc.

Note also that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for controlling an interactive teleconference, the method comprising:
establishing at least one rule for an interactive teleconference, wherein said at least one rule defines a condition that must be met before at least one participant in the interactive teleconference is enabled to transmit a message during the interactive teleconference;
initiating a preliminary stage of the interactive teleconference, wherein said at least one participant's ability to transmit a message to other participants in the interactive teleconference is disabled;
determining if the condition of said at least one rule has been met;
in response to the condition of said at least one rule not being met, continuing to disable said at least one participant's ability to transmit said message to other participants in the interactive teleconference; and
in response to the condition of said at least one rule being met, enabling said at least one participant's ability to transmit a message to other participants in the interactive teleconference.

2. The method of claim 1, wherein the interactive teleconference is an Instant Messaging (IM) session.

3. The method of claim 1, wherein the interactive teleconference is a video conference.

4. The method of claim 1, wherein the condition is one or more pre-named participants signing in to the interactive teleconference.

5. The method of claim 1, wherein the condition is a pre-determined date and time being reached.

6. The method of claim 1, wherein the condition is an occurrence of a pre-determined external event, wherein the pre-determined external event is pre-defined as requiring an initiation of the interactive teleconference.

7. The method of claim 6, wherein the pre-determined external event is an unplanned emergency, wherein the interactive teleconference is required to respond to the unplanned emergency.

8. The method of claim 1, wherein the condition is all participants signing in to the interactive teleconference.

9. A computer-readable medium encoded with a computer program, the computer program comprising computer executable instructions configured for:
establishing at least one rule for an interactive teleconference, wherein said at least one rule defines a condition that must be met before at least one participant in the interactive teleconference is enabled to transmit a message during the interactive teleconference;
initiating a preliminary stage of the interactive teleconference, wherein said at least one participant's ability to transmit a message to other participants in the interactive teleconference is disabled;
determining if the condition of said at least one rule has been met;
in response to the condition of said at least one rule not being met, continuing to disable said at least one participant's ability to transmit said message to other participants in the interactive teleconference; and
in response to the condition of said at least one rule being met, enabling said at least one participant's ability to transmit a message to other participants in the interactive teleconference.

10. The computer-readable medium of claim 9, wherein the interactive teleconference is an Instant Messaging (IM) session.

11. The computer-readable medium of claim 9, wherein the interactive teleconference is a video conference.

12. The computer-readable medium of claim 9, wherein the condition is one or more pre-named participants signing in to the interactive teleconference.

13. The computer-readable medium of claim 9, wherein the condition is a pre-determined date and time being reached.

14. The computer-readable medium of claim 9, wherein the condition is an occurrence of a pre-determined external event, wherein the predetermined external event is pre-defined as requiring an initiation of the interactive teleconference.

15. The computer-readable medium of claim 14, wherein the pre-determined external event is an unplanned emergency, wherein the interactive teleconference is required to respond to the unplanned emergency.

16. The computer-readable medium of claim 9, wherein the condition is all participants signing in to the interactive teleconference.

17. The computer-useable medium of claim 9, wherein the computer executable instructions are deployable to a client computer from a server at a remote location.

18. The computer-useable medium of claim 9, wherein the computer executable instructions are provided by a service provider to a customer on an on-demand basis.

19. A system comprising:
a processor;
a data bus coupled to the processor;
a memory coupled to the data bus; and
a computer-usable medium embodying computer program code, the computer program code comprising instructions executable by the processor and configured for:
establishing at least one rule for an interactive teleconference, wherein said at least one rule defines a condition that must be met before at least one participant in the interactive teleconference is enabled to transmit a message during the interactive teleconference;
initiating a preliminary stage of the interactive teleconference, wherein said at least one participant's ability to transmit a message to other participants in the interactive teleconference is disabled;
determining if the condition of said at least one rule has been met;
in response to the condition of said at least one rule not being met, continuing to disable said at least one participant's ability to transmit said message to other participants in the interactive teleconference; and
in response to the condition of said at least one rule being met, enabling said at least one participant's ability to transmit a message to other participants in the interactive teleconference.

20. The system of claim 19, wherein the interactive teleconference is an Instant Messaging (IM) session.
